(19) United States
(12) Patent Application Publication
(10) Pub. No.: US 2007/0172713 A1
(43) Pub. Date: Jul. 26, 2007

(54) Stress reducing bus bar for an electrolyte sheet and a solid oxide fuel cell utilizing such

(76) Inventors: Thomas Dale Ketcham, Big Flats, NY (US); Dell Joseph St Julien, Watkins Glen, NY (US); Cameron Wayne Tanner, Horseheads, NY (US)

Correspondence Address: CORNING INCORPORATED, SP-TI-3-1, CORNING, NY, 14831, US

(21) Appl. No.: 11/338,128

(22) Filed: Jan. 23, 2006

(51) Int. Cl. H01M 8/24; H01M 8/12; H02G 5/00

(52) U.S. Cl. 429/32; 429/34; 174/68.2

(57) ABSTRACT

A bus bar for an electrolyte sheet is provided that includes a bus strip of electrically conductive material in contact with a side edge of the cell or cells in the electrolyte sheet, wherein the amount of material in shoulder portions of the bus strip decreases as the strip approaches end portions of the cell edge to reduce stress. Preferably, such material reduction is accomplished by tapering the shoulder portions of the bus strip. The tapered shape of the shoulders reduces the amount of electrical conductor needed to form the bus bar. The stress reducing bus bar also includes a lead which is orthogonally oriented with respect to the longitudinal axis of the side edge of the cell. The tapered shape of the shoulder portions of the bus strip, in combination with the orthogonally oriented lead, reduces stresses that would otherwise occur between the bus bar and the electrolyte sheet as a result of differences in the thermal coefficient of expansion. The specific shape of the taper in the shoulder portions is selected such that I²R losses are substantially minimized along the longitudinal axis of the bus strip.

### FIELD OF THE INVENTION

This invention generally relates to solid oxide fuel cells, and is particularly concerned with a stress reducing bus bar on the electrolyte sheets mounted within such a fuel cell.

### BACKGROUND OF THE INVENTION

Solid oxide fuel cell devices incorporating flexible ceramic electrolyte sheets are known in the prior art. In such fuel cell devices, one or more electrolyte sheets are supported within a housing between a pair of mounting assemblies, which might be either a frame or a manifold. The electrolyte sheets may be utilized either in a multi-cell or single cell design. In a multi-cell design such as that disclosed in U.S. Pat. No. 6,623,881 assigned to Corning Incorporated, the fuel cell device includes an electrolyte sheet in the form of a sheet of zirconia doped with yttrium oxide (Y₂O₃) that may be about 20 microns thick. The doped zirconia sheet supports a plurality of rectangular cells, each of which is formed by an anode and cathode layer on either side of the doped zirconia sheet, and each of which may be between 4 and 8 microns in thickness. Such multi-cell devices are flexible.

An alternative approach utilizes a fuel cell device that utilizes a single cell design where the thickest component of the fuel cell is a ceramic anode layer. This anode layer can be about 100 to 1000 microns in thickness and is often be formed from a composite of nickel and yttria stabilized zirconia. Such single cells further include a thin electrolyte layer overlying the anode layer, and a cathode layer overlying the electrolyte.

In both multi-cell and single cell fuel cell devices, bus bars can be provided to collect the current generated by either the array of multiple cells supported by the electrolyte sheet or from the single cell fuel cell device described above. Such bus bars are generally provided along the top and bottom portions of each electrolyte sheet in contact the current-carrying vias spaced along top and bottom edges of either the array of rectangular cells, or the single cell. In both cases, the bus bars include a bus strip formed from a heat-resistant, electrically conductive alloy such as silver-palladium which has been screen-printed over the top and bottom edges of the cells or cell, and then sintered into the material forming the top and bottom edges of the multi-cell array or single cell of the electrolyte sheet. In addition to a current-collecting bus strip that extends across the length of the top and bottom edges of the cells or cell, such bus bars further include either a lead strip or a lead wire for conducting the current generated by the array of cells out of the solid oxide fuel cell. In the prior art, such lead strips or lead wires are aligned along the length of the bus strip, and extend out the sides of the solid oxide fuel cell. The bus strips of prior art bus bars are generally rectangular in shape, and function to electrically connect the row of current conducting vias along the upper and lower edges the cells or cell on the electrolyte sheets may be used.

While the aforementioned prior art design is effective in generating an electrical current from the exchange of electrons that occurs when hydrogen and oxygen are chemically reacted in a stack of such electrolyte sheets in a solid oxide fuel cell, the applicants have observed certain shortcomings associated with the previously-described bus bar design that can adversely affect the longevity of the solid oxide fuel cell. Specifically, the applicants have observed that both tensile and bending stresses are generated in the electrolyte sheets in the vicinity of the shoulder portions of the prior art bus strips. These stresses are believed to be a result of differences in the material forming the electrolyte sheet. Because of the intense thermal shock generated by the rapid cycling of the fuel cell device between ambient temperature, and an operating temperature of approximately 750° C., even modest differences in the CTE between the bus bars and the electrolyte sheets have been found to generate stresses in the shoulder portions of the bus bars that are sufficiently intense to create cracking in the corner portions of the electrolyte sheets over time. The applicants have observed that these stresses are particularly high on the shoulder portion where the lead strip is connected to the bus strip.

Clearly, what is needed is an improved bus bar that eliminates or at least reduces stresses in the corner portions of the electrolyte sheet caused by CTE differences. Ideally, such an improved bus bar could be easily manufactured in accordance with presently available manufacturing techniques. Finally, it would be desirable if such an improved bus bar could be made with smaller amounts of expensive heat resistant alloys without increasing I²R losses in the current generated by cell or cells on the electrolyte sheet.

### SUMMARY OF THE INVENTION

Generally speaking, the invention is a bus bar for an electrolyte sheet in a solid oxide fuel cell that solves or at least ameliorates the aforementioned problems associated with the prior art. To this end, the bus bar of the invention comprises a bus strip of electrically conductive material in contact a side edge of the cell or array of cells on the electrolyte sheet, wherein the amount of material in shoulder portions of the bus strip decreases as the strip approaches end portions of the side edge. Such a decrease in material advantageously reduces stresses that would otherwise occur in the shoulder portions as a result of CTE differences between the bus strip, which is preferably metallic, and the cells in the electrolyte sheets, which are preferably formed of a composite ceramic-metal material, as well as the ceramic electrolyte sheet. Preferably, the rate of decrease in the material in the shoulder portions of the bus strip in the shoulder portions is selected such that I²R losses experienced by the current conducted out of the uniformly-spaced vias along the cell edge is minimized.

Preferably, the bus bar of the invention further comprises at least one lead strip connected to the bus strip that is transversely oriented with respect to the longitudinal axis of the bus strip. Preferably, the lead strip is substantially orthogonal with respect to the bus strip. Such an orientation further advantageously reduces stresses in the shoulder portions of the bus strip caused by differences in the CTE between the bus strip and the cell of the electrolyte sheet. When a single lead strip is used, the bus strip includes only two shoulder portions that flank either side of the lead strip, and the amount of material in these shoulder portions is reduced at each point between the lead strip and the end portions of the edge of the cell or cells on the electrolyte sheet. When two or more lead strips are used, the lead strips are preferably uniformly spaced along the longitudinal axis of the edge of the cell or cells of the electrolyte sheet, and shoulder portions with continuously decreasing material are provided on both sides of each dead strip. Preferably, the rate of reduction of material along the longitudinal axis of the bus strip is selected such that I²R losses are minimized with little variation across the length of the bus bar. Such a decrease in material may be effected by tapering of the bus bar cross along its length in a direction away from the location of the lead strip Such tapering results in a more efficient use of the bus-bar material than a rectangular shape. The resulting reduction of material along central portions of the bus strip not only further reduces stresses due to differences in the thermal coefficient of expansion of the bus strip and the cell or cells on the electrolyte sheet, but further advantageously reduces the amount of heat resistant alloy necessary to form the bus bar without increasing I²R losses. This is important, since the electrically conductive materials forming the bus bar can include expensive metals such as palladium and platinum that are alloyed with silver.

The reduction in the material of the bus strip along the longitudinal axis of the cell edge is preferably accomplished by tapering the bus strip width, rather than by varying the thickness of the strip along the longitudinal axis of the cell edge. While such tapering may be made with straight lines, curved lines may provide further reductions in stresses generated between the bus strip and the edge of the cell.

The stress reducing bus bar of the invention advantageously reduces not only potentially-damaging stresses in the electrolyte sheets used in solid oxide fuel cells, but further reduces the amount of expensive materials necessary to fabricate the bus bar without increasing I²R losses in the output current of the cell.

### DESCRIPTION OF THE DRAWINGS

FIG. 1 is a perspective view of a prior art solid oxide fuel cell that the stress reducing bus bar of the invention may be used in;

FIG. 2A is a plan view of an electrolyte sheet, illustrating in particular one type of bus bar used to conduct current generated by the sheet outside of the fuel cell;

FIG. 2B is a cross-sectional view of the electrolyte sheet of FIG. 2A along the line 2B-2B;

FIG. 3 is a plan view of an electrolyte sheet that uses a different type of bus bar;

FIGS. 4A and 4B are a plan and oblique view of a free body analysis of a fuel cell device incorporating the electrolyte sheet such as that shown in FIGS. 2A-2B and 3, illustrating the distribution of tensile and bending stresses present during the operation of such device;

FIG. 5 is a plan view of a first embodiment of the bus bar of the invention installed in an electrolyte sheet;

FIG. 6 is a plan view of a second embodiment of the bus bar of the invention installed on a fuel cell device on an electrolyte sheet;

FIG. 7 is a plan view of a third embodiment of the invention installed on a fuel cell device on an electrolyte sheet;

FIG. 8 is a plan, schematic view of fuel cell device using a fourth embodiment of the bus bar of the invention, and further identifying parameters used in determining the relative electrical resistances of rectangular versus tapered bus bars having the same amount of material, and

FIGS. 9A and 9B compare the percent increases in resistance over length between a rectangular bus bar and a tapered bus bar, respectively, for device having between 1 and 75 cells.

### DETAILED DESCRIPTION OF THE PREFERRED EMBODIMENT

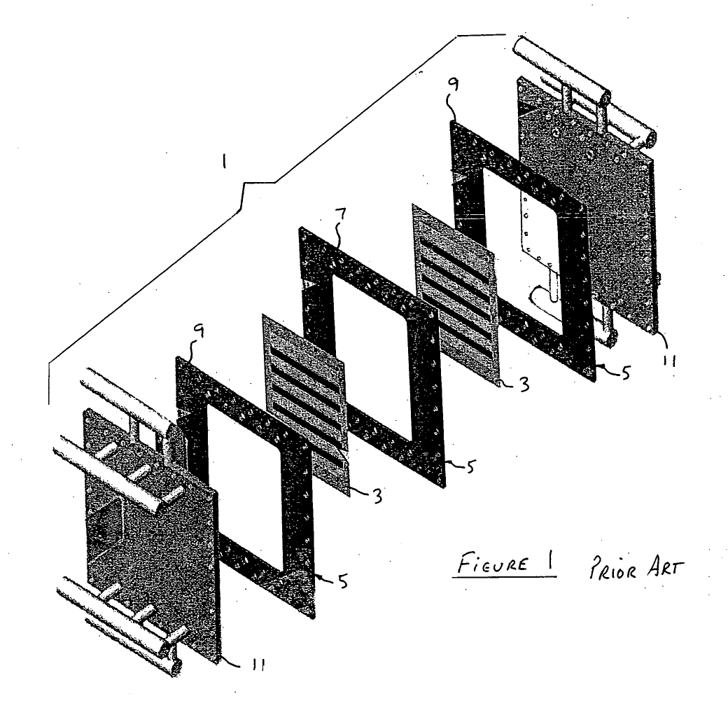

With reference to FIG. 1, wherein like numbers designate like components throughout all the several figures, the stress-reducing bus bar of the invention may be used in solid oxide fuel cells of the solid oxide fuel cell assembly 1, wherein fuel cell devices are supportedwithin the fuel cell assembly 1 by support assemblies 5 taking the form of a fuel frame 7 flanked by a pair of air frames 9. The fuel cell devices are clamped and sealed between the frames 7, 9 by a pair of end plates or manifolds 11. It should be noted that the solid oxide fuel cell assembly 1 illustrated in FIG. 1 is only one of many designs and that the stress-reducing bus bar of the invention may be used in connection with many others. Generally speaking, the invention is applicable to any electrodes on an electrolyte sheet that is designed to be compliant (i.e., electrolyte having a thickness of less than about 150 microns, preferably less than 45 microns, more preferably less than 25 microns) in response to the thermal shock and pressure differentials that such sheets are exposed to in the interior of a solid oxide fuel cell.

However, while the invention is most advantageous for use in fuel cell devices that utilize thin electrolyte supporting multiple cells, the bus bar according to the present invention may be advantageously utilized (due to the associate cost reduction and other advantages) in any fuel cell devices that utilize edgewise current collection. Such fuel cell devices may be, for example, electrolyte supported single cell devices, or the anode or cathode supported devices, or devices supported on porous substrates which can have multiple cells on the single porous substrate.

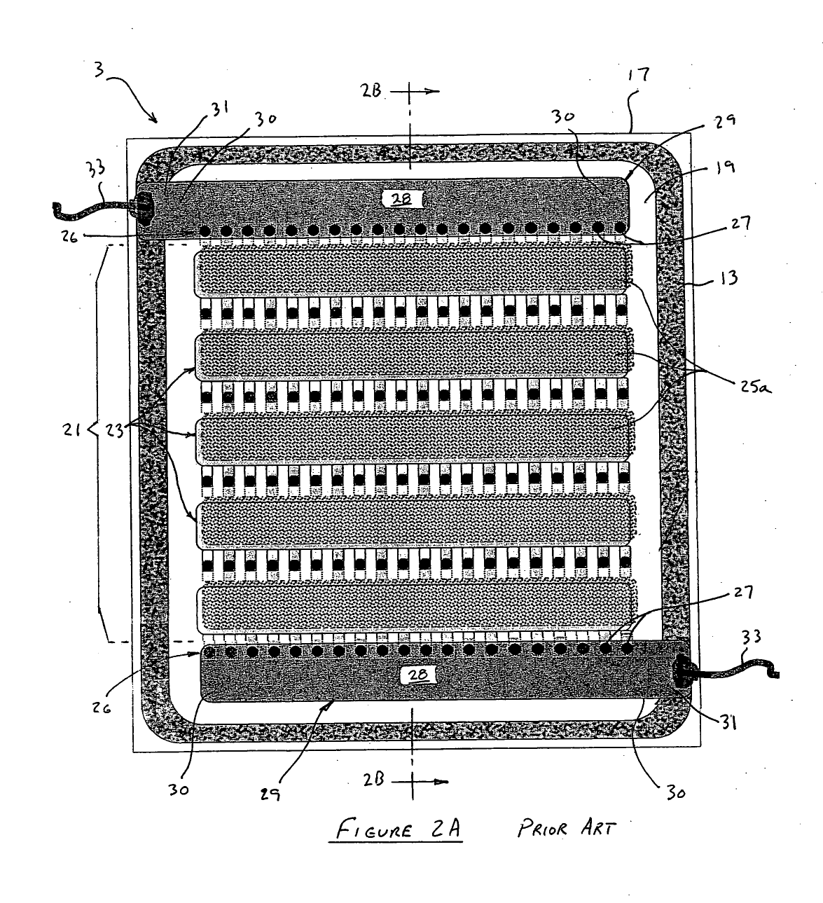

With reference now to FIGS. 2A and 2B, the fuel cell device 3 used in such solid oxide fuel cells assembly 1 are secured within the aforementioned frames 7, 9 by means of a seal 13 which bonds the entire outer edge of the electrolyte sheet 17 of the fuel cell device 3 to the frame 7. The seal 13 is typically formed from a heat resistant cermets material capable of bonding with both the ceramic material forming the peripheral portion 19 of the electrolyte sheet 17 of the fuel cell device 3, and the metal forming the frame 7. In a multi-cell electrolyte sheet, a fuel cell array 21 is provided in the central portion in the electrolyte sheet as shown. The array 21 typically includes between two and 500 individual fuel cells 23 (for example, 10, 60, 100, 200, 250, 300, 350, or 400 cells), each of which includes an anode 25a and cathode 25b disposed on opposite sides of the electrolyte sheet 17. Thus, in this embodiment, the electrolyte sheet 17 (also referred as a support sheet herein) supports an array 21 of individual fuel cells and is less than 45 microns thick. In some embodiments the electrolyte thickness is between 15 and 25 microns. The electrolyte support sheet 17 may be formed of zirconia doped with 3% yttrium oxide (Y₂O₃) In this embodiment the electrolyte sheet 17 is approximately 20 microns thick. The anode and cathode 25a, 25b on either side of the electrolyte sheet 17 are both formed from a cathode layer and an anode layer (not shown) over which a current collecting material formed from a silver palladium alloy (also not shown) is provided. The cathodes and anodes 25a, 25b with the current collectors are each approximately 25 microns thick. As is best seen in FIG. 2B, a row of vias (formed by metal-filled holes in the electrolyte sheet 17 (support sheet)) connect adjacent cells 23 in series, with the anode 25a of one cell being connected to the cathode 25b of an adjacent cell. Such a structure advantageously increases the voltage of the electricity generated by the fuel cell device 3, which includes an electrolyte sheet 17 and an array of individual fuel cells 23 connected by vias.

With reference back to FIG. 2A, prior art bus bars 28 are provided in the fuel cell device 3 in order to collect the current generated by the cell array 21 and to conduct it outside the fuel cell assembly. To this end, such bus bars 28 include a rectangular bus strip 29 formed from a layer of a heat resistance alloy, such as silver-palladium, having a uniform thickness of between about 10-25 microns. Such bus strips are typically between about ten and twenty centimeters in length, and are formed by screen printing particulate silver-palladium on the electrolyte support sheet 17 and then heating the electrolyte sheet 17 to temperatures of between about 800 to 1,000° C. to sinter the silver-palladium particles together and to fuse them to the upper and lower rows 26 of vias 27 as well as to the surface of the electrolyte sheet 17. (In this embodiment, the electrolyte sheet 17 is also referred to as the “support sheet” because its supports the plurality of electrodes, the vias, and the bus bars.) Bus strip 29 includes opposing slightly rounded square shoulders 30 as shown. Integrally formed with one of these shoulder portions 30 is a side portion 31 that extends over the seal 13. A lead wire 33 bonded to the side portion 31 of each of the bus strips 29 conducts electricity generated by the cells 23 outside the fuel cell.

Bus bars 28 are generally categorized as anode bus bars and cathode bus bars, depending upon whether they are connected to the positive or negative end of the cell array 21. In this application, the term “bus bar” shall apply to both. Also, while the anode and cathode bus bars illustrated throughout the several Figures are shown as being on the same side of the electrolyte sheet 17 of the fuel cell device 3, they may be on opposite sides of the electrolyte sheet 17 as well. Such a structure is common, and may utilize a dummy row of vias 27 if is necessary for both bus bars 28 to be on the same side of the electrolyte sheet. Finally, while such bus bars 28 are commonly formed from silver-palladium alloys, they may also be formed from platinum alloys or alloys of nickel and other metals or other electronic conductors (including conductive ceramics and cerments) having heat resistant qualities. The invention is intended to apply to all such bus bars, regardless of their specific structure, composition or arrangement on the electrolyte sheet 17. In the case of silver palladium bus bars, bus bars can be printed on both the cathode and anode side on both ends of the device with similar thickness and connected through the electrolyte sheet with vias. The similar thickness on both sides of the electrolyte avoids CTE induced bending and fracture due to the symmetry across the electrolyte mid plane. When vias electrically connect both the anode and the cathode side bus bars, the bus bar I²R losses are approximately halved. Similar advantage can be realized when the anode side bus bar and cathode side bus bar are not the same composition (for example, silver palladium or platinum, other oxidation resistant metals and conductive ceramics or cerments for the cathode side; and nickel or a nickel alloys or other low resistance metals for the anode side). One would balance the CTE difference, E-modulus and thickness to obtain a relatively stress free state in the electrolyte. Although metal can be on both sides of the electrolyte, the bus bars on the ends of the solid oxide fuel cell device are electrically connected to an end cathode and an end anode.

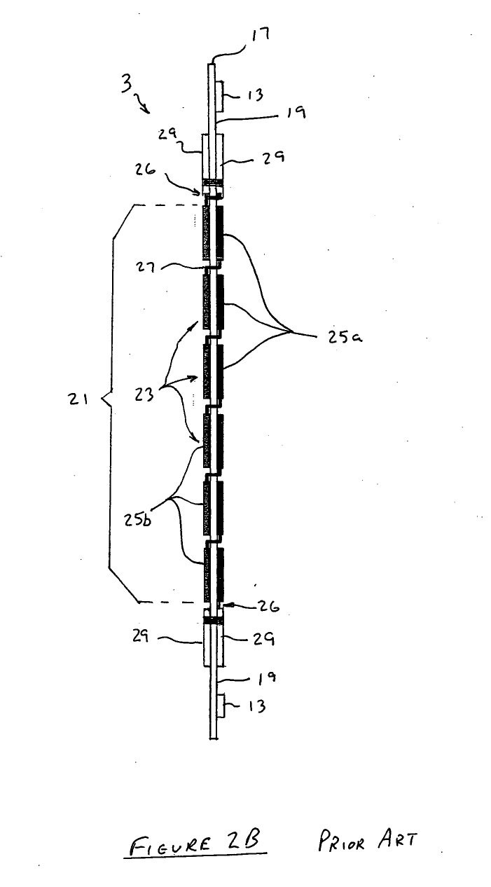

FIG. 3 is a plan view of the fuel cell device 3 having an alternate form of prior art bus bar 34. This bus bar 34 is identical in structure to the previously described, bus bar 28 with the exception that there are no side portions 31 that extend from one side of the bus strip 29 through the seal 13. Instead, leads (lead wires) 33 attached onto the square shoulder portions 30 of the bus strip 34 conduct electricity generated by the cells 23 outside of the solid oxide fuel cell assembly 1.

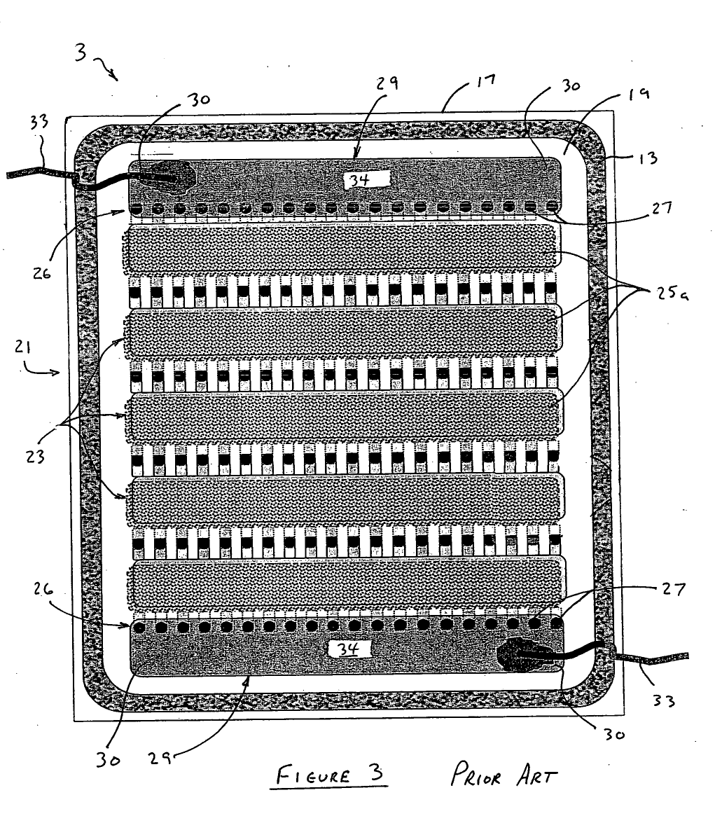

While both of the prior art bus bars 28 and 34 are effective in carrying out their intended purpose, a free body stress analysis of electrolyte sheets provided with such bus bars reveals how the slightly rounded square shoulder portions 30 present in both types of such bus bars generates high concentrations of tensile and bending stresses in both the corners and along the edge of the support sheet 17 of the fuel cell device 3. FIGS. 4A and 4B illustrate the results of such an analysis conducted by the applicants. Applicants have observed that these stresses are caused by the differences in the coefficient of thermal expansion (CTE) of the palladium-silver alloy forming the bus bars 28, 34 and the predominately ceramic material forming the electrolyte support sheet 17. The magnitude and locations of these stresses is about the same whether a side portion 31 or a laterally oriented lead wire 33 is used to conduct electricity out of the fuel cell assembly 1. Because of the broad temperature range (20° C. to 750° C.) that the fuel cell device 3 are cycled through during the operation of the fuel cell, even relatively small differences in the CTE, over time, can generate stresses severe enough to cause cracking in the corners and along the edges of the support sheet 17, thus degrading the ability of the fuel cell device 3 to generate electricity. The present invention was designed to eliminate these undesirable stress concentrations in the corners and along the edges of the support sheet 17.

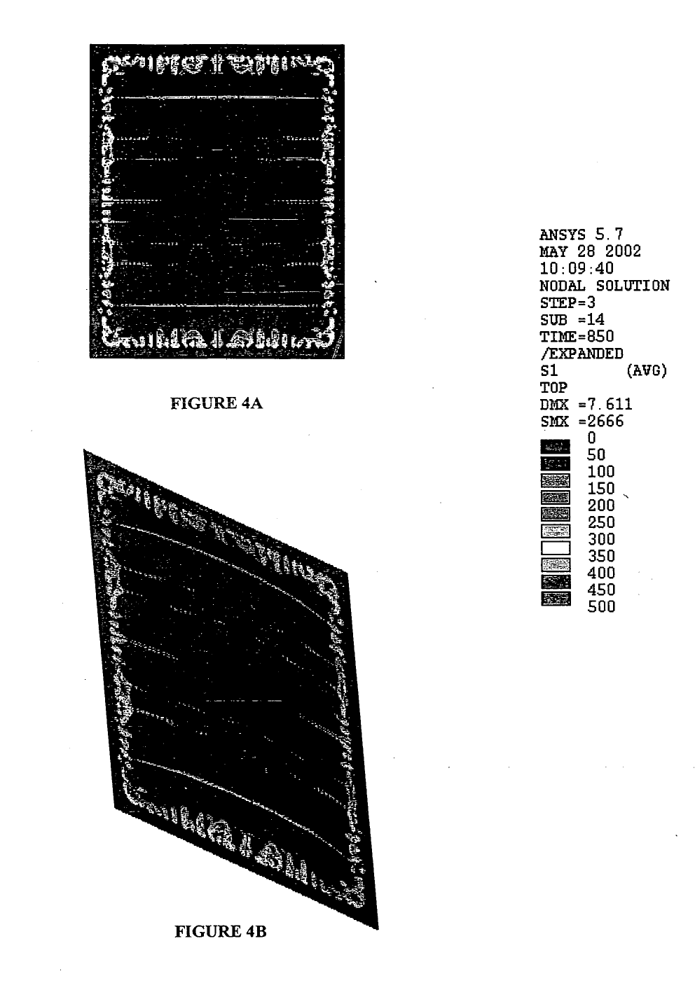

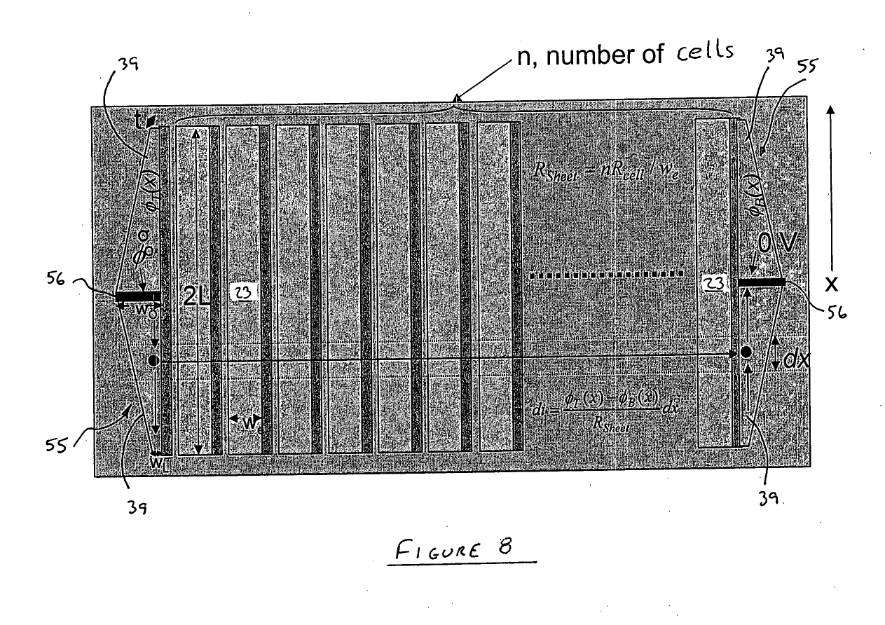

FIG. 5 illustrates a first embodiment 35 of the bus bar of the invention. In this first embodiment, the bus strip 37 of the bus bar 35 includes outside shoulder portions 39 which are tapered toward the end portions of the upper and lower rows 26 of vias 27. The reduction of the amount of silver-palladium material in the bus strip 37 toward the end portions of the upper and lower rows of vias 26 has been found to affectively reduce the tensile and bending stresses created by differences in CTE in the shoulder portions 39 of the bus bar 35. The bus bar according to the present invention may also reduce the amount of material utilized in the bus bar and thus lower the associated cost. Additionally, the inventive bus bar 35 includes lead strips 41a, 41b which are uniformly spaced along the length of the upper and lower rows of vias 26 and which are oriented transversely, and preferably orthogonally with respect to the longitudinal axes of the rows 26. Such an orientation of the lead strips 41a, 41b has been found to further lower tensile and bending stresses which would otherwise be concentrated in the corner portions of the support sheet 17 of the fuel cell device 3. It should be noted that the number of orthogonally-oriented lead strips 41a, 41b can vary between a single lead strip (such as that which might be used in conjunction with the fourth embodiment of the invention illustrated in FIG. 8), to several uniformly spaced leads (also referred to as a lead strips). The number of vias 27 in any of the rows 26 can vary between about five and several hundred, and the number of lead strips would preferably be about four for an electrolyte sheet having rows 26 containing fifty vias 27, but only one lead for an electrolyte sheet having rows 26 containing about ten vias. Of course, different number of rows and vias, as well as the leads may also be utilized. In the disclosed embodiments, the preferred orthogonally-oriented lead strip or strips 41a, 41b advantageously tend(s) to dissipate stresses caused by differences in the CTE of the silver-palladium alloy forming the bus bar 35, and the support sheet 17 by re-oriented these forces away from the width of the fuel cell device 3. Other device configurations may utilize non-uniform lead spacing or asymmetric tapering where manifolding or the fuel cell assembly, or the fuel cell stack, or other factors dictate lead locations not having either symmetric tapers or uniform spacing of leads.

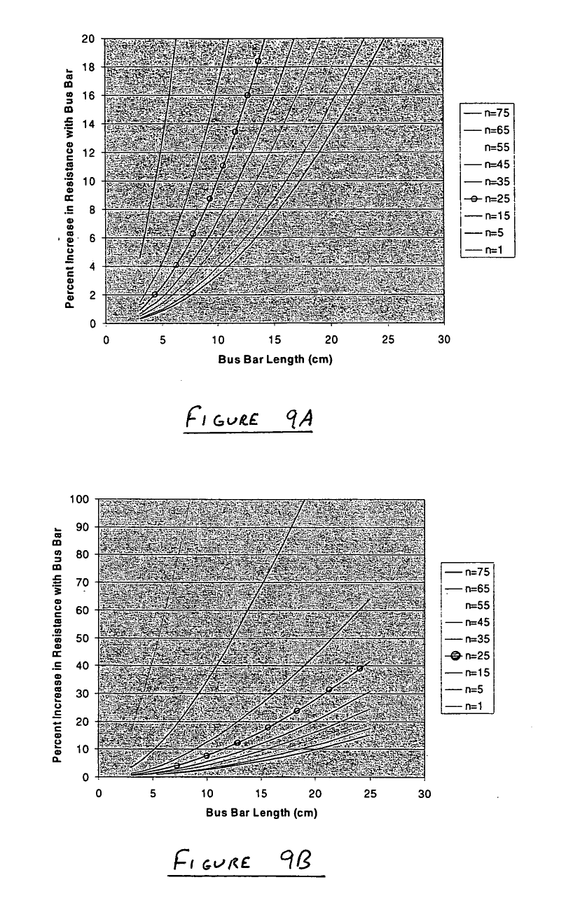

While it would be possible to reduce the material in the outside shoulder portions 39 by rendering it thinner toward the end portions of the upper and lower rows of vias 26, the preferred mode of carrying out the invention is to maintain the thickness of the bus strip 39 uniform across its length, while tapering the outside shoulder portions in the manner illustrated, as such tapering of the outside shoulder portions 39 may be easily implemented by conventional screen-printing methods currently in use to manufacture such bus bars. A bus bar that utilizes combination of thinner end portions with tapering may also be advantageous. The applicants have serendipitously found that such tapering of the bus strip 37 not only advantageously reduces undesirable tensile and bending forces in the support sheet 17, but also allows less of the relatively expensive palladium-silver alloy to be used in the bus strip 37 without increasing the I²R losses imposed on the current conducted from the vias 27 through the lead strips 41a, 41b. The basis for this observation will be set forth in greater detail hereinafter with respect to FIGS. 8 and 9. The fact that such a tapered shape may be advantageously used in the outside shoulder portions 39 without increasing I²R losses lead to the applicant's further observation that, in instances where two or more lead strips 41a, 41b are used, the inside shoulder portions 45 flanking the opposite sides of the lead strips 41a, 41b may likewise be tapered without imposing additional I²R losses on the current conducted from the upper and lower rows 26 of vias 27. Tapering of the width of the bus bar away from the lead contact makes more efficient use of the same amount of bus bar material, or allows less material to be used for the same amount of resistive loss. There is a modest impact to tapering if the amount of material is not adjusted to obtain the same resistance such as by increasing the thickness of the bus bar. The total amount of material in the tapered bus bar is still less than one with a uniform width. The end result is that the bus bar 35 of the invention may be fabricated with substantially less palladium-silver alloy than the prior art bus bars illustrated in FIGS. 2A, 2B and 3 without any increase in resistive losses to the electrically current generated by the fuel cell device 3.

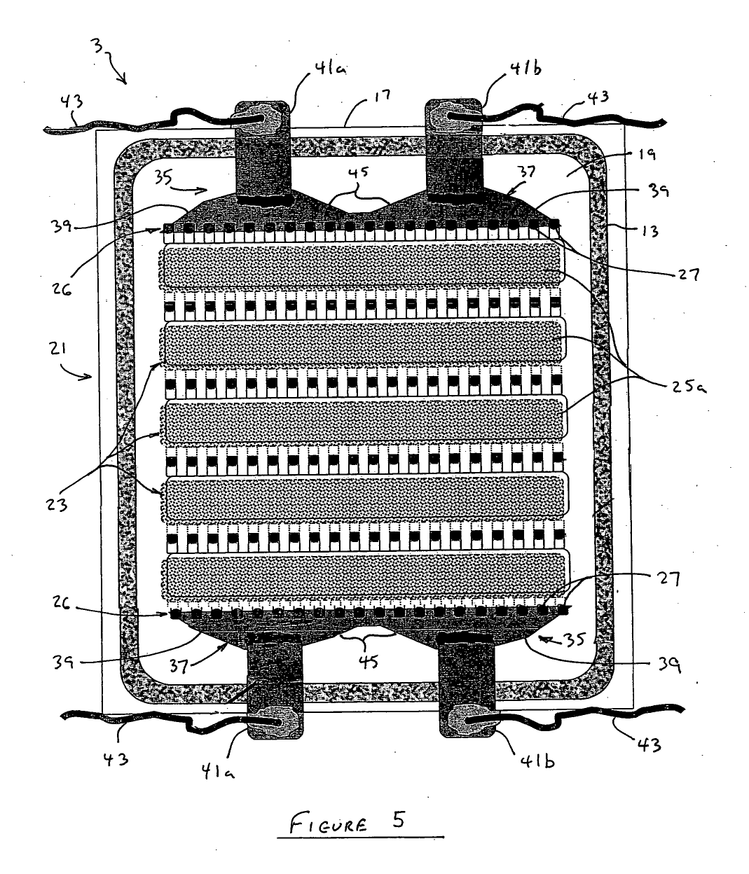

FIG. 6 illustrates a second embodiment 47 likewise having tapered outside shoulder portions 39 and tapered inside shoulder portions 45. However, instead of the angular tapered shape of the embodiment 35 illustrated in FIG. 5, the shoulders 39, 45 in the FIG. 6 embodiment 47 includes curved or beveled edges 49. The curving or beveling of the edges 49 of both the outside and inside shoulder portions 39, 45 further reduces concentrations of bending and tensile stresses in the corner portions of the support sheet 17 of the fuel cell device 3.

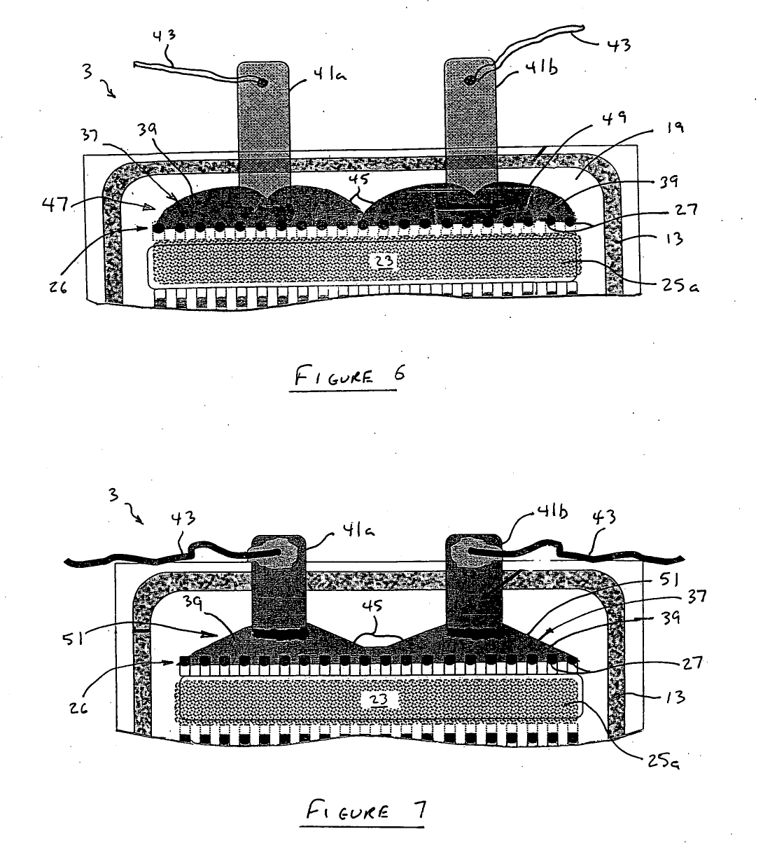

FIG. 7 illustrates a third embodiment 51 of the invention wherein the tapered shape of the outside and inside shoulder portions 39, 45 is defined by a straight edge. Hence, when the term “tapered” is used in the present specification, such tapering may be accomplished by angular edges, by curved edges, or straight edges. Any such tapering or other shaping wherein the amount of material in the outside shoulder portions 39 is reduced (and preferably substantially continuously reduced along each point of the outer edges) in the direction toward the end points of the upper or lower rows 26 of vias 27 is within the scope of this invention. Where two or more lead strips 41a, 41b are used, any bus bar using such lead strips oriented transversely and preferably orthogonally to the longitudinal axes of the upper and lower rows 26 of vias 27 is also included within the scope of this invention. Finally, any such bus bar using the combination of two or more transversely or orthogonally-oriented lead strips 41a, 41b wherein the amount of material in the bus strip is reduced in directions away from such lead strips is also encompassed within the scope of this invention. Although orthogonal orientation of the lead strips is preferred, other lead attachments geometries may be used as required for ease of fuel manifolding, fuel cell assembly, or fuel cell stack construction. Such orientations may include parallel or diagonal lead orientation, combinations thereof, or attachment at an angle.

FIG. 8 not only illustrates a fourth embodiment 55 of the bus bar of the invention having only two shoulder portions 39, where a single lead strip is centrally attached at area 56. This embodiment is labeled with various electrical and geometric parameters which, when inserted into the equations to be discussed hereinafter, demonstrate that a bus bar having a tapered bus strip has less electrical resistance for the same amount of material than a bus bar having a rectangular bus strip. This analysis assumes that all current transport is ohmic, and further ignores horizontal flows of current in the bus bars on either side of the electrolyte sheet, as well as vertical flow of current in the fuel cell device 3. Further, it assumes that both bus bars shown in FIG. 8 are of identical size and shape.

As is indicated in FIG. 8,
2 L=length of bus strip;
x=distance from outer edge to center of bus strip'
wₒ=width of bus strip at center;
w_{L}=width of bus strip at ends;
wₑ=width of a cell in cell array;
n=number of cells in cell array;
Φ_{T}=voltage of left bus strip;
Φ_{B}=voltage of right bus strip;
t=thickness of bus strip, and
σ=conductivity of the bus strip material.
R_{Total}=area specific resistance of a cell repeat unit including resistance of the via(s)

Applying Kirchhoff's law to current flow in first and second bus strips, and expressing current as voltage divided by resistance, we get:

$$\begin{matrix}( First bus strip ) & - \frac{ⅆ}{ⅆ x} ( w ( x ) \frac{ⅆ {ϕ}_{T}}{ⅆ x} ) + \frac{{ϕ}_{T} - {ϕ}_{B}}{σ t {R}_{Sheet}} = 0 \\ ( Second bus strip ) & - \frac{ⅆ}{ⅆ x} ( w ( x ) \frac{ⅆ {ϕ}_{B}}{ⅆ x} ) + \frac{{ϕ}_{B} - {ϕ}_{T}}{σ t {R}_{Sheet}} = 0\end{matrix}$$

where w(x) is a function expressing change in the width of the bus strip over the length x.

Applying Ohm's law, the resistances of the first and second bus strips may be expressed as follows:

$$i = \frac{1}{{R}_{Sheet}} {\int }_{0}^{L} ( {ϕ}_{T} - {ϕ}_{B} ) ⅆ x$$

$${R}_{Total} = \frac{L {ϕ}^{o}}{i}$$

$${R}_{BB} = {R}_{Total} - {R}_{Sheet}$$

where Φ⁰ is the voltage at the center of the bus strips, and i=current.

The resistance of a “straight” (prior art) bus strip may accordingly be expressed as follows:

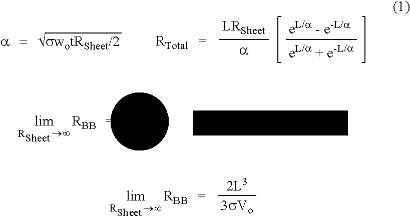

By contrast, the resistance of a tapered bus strip of the invention may be expressed as follows:

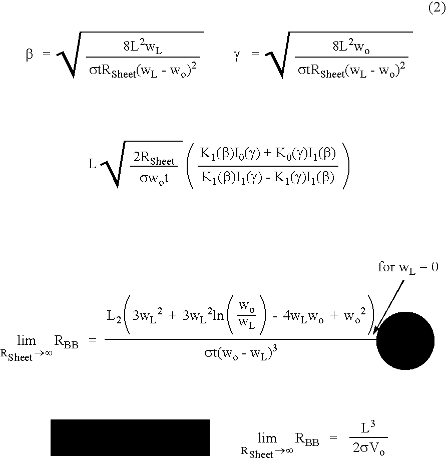

A simple comparison of equations (1) and (2) above demonstrates that a tapered bus strip having the same amount of conductive material (i.e., palladium-silver alloy) has

$$\frac{2 {L}^{3}}{3 σ {V}_{o}} - \frac{{L}^{3}}{2 σ {V}_{o}} = \frac{{L}^{3}}{6 σ {V}_{o}}$$

less resistance than a straight, prior art bus strip. On a simple percentage basis, wherein

$$\frac{2 {L}^{3}}{3 σ {V}_{o}} = 100 \%$$

this amounts to a 25% reduction in resistance for bus strips made of the same amount of material. Since there is a generally linear relationship between the amount of material in a bus strip and the amount of electrical resistance in the strip, the foregoing analysis indicates that a tapered bus strip formed in accordance with the invention may have 25% less conductive material as a straight, prior art bus strip without increasing the electrical resistance or I²R losses on the output current.

FIGS. 9A and 9B compare the percentage increase in resistance of a bus bar for a straight or rectangular prior art bus strip, and a tapered bus strip in accordance with the invention, respectively. The family of curves present on both of the graphs of these figures represent such a percentage increase in resistance over bus bar length for fuel cell device 3 having fuel cell arrays 21 containing between one cell (i.e., the right-most curve), and seventy-five cells (i.e. the left most curve), with fuel cell device 3 having cell arrays of five, fifteen, twenty-five, thirty-five, forty-five, fifty-five and sixty-five cells disposed in between these two curves. Both of the family of curves illustrated in these figures assumes that the resistance of each cell is 0.7 ohms per square centimeter, the width of each cell is 0.8 centimeters, the thickness of both the straight and tapered bus strips is 6 microns, and the conductivity of the bus bar material is 25,000 S/cm. It is further assumed that the straight bus strip has a constant width of 2.0 centimeters, and the tapered bus strip has a maximum width of 4.0 centimeter, and a minimum width at the ends of the shoulder portions of 0.0 centimeters.

In all cases, the percentage increase in resistance is substantially lower in the tapered bus bar of the invention than in a straight, rectangular prior art bus bar. Compare, for example, the graphs in FIGS. 9A and 9B for an electrolyte sheet having twenty-five cells and a bus bar length of twelve centimeters. FIG. 9A indicates that, for a bus bar having a straight, prior art bus strip, that the increase in resistance would be approximately 14%. By contrast, FIG. 9B indicates that the increase in resistance for a bus bar having a tapered bus strip would be about 11%. These differences are generally greater for electrolyte sheets having a fewer number of cells, and decrease as the number of cells increases. However, as pointed out previously, the resistances, in all cases, are smaller for a bus bar having a tapered bus strip when the bus strips contain the same amount of conductive material.

Although this invention has been described with respect to four preferred embodiments, various modifications and additions will become apparent to persons of skill in fine art. For example, while the various figures indicate that the term “tapering” indicates that the amount of material on the shoulder portions of the bus strip is reduced at every point along the length of the bus strip approaching the end portions of the upper and lower rows of vias, the material may also be reduced in a step-like manner and still obtain the advantages of the invention. All such variations, modifications and additions are intended to fall within the scope of the invention, which is limited only by the appended claims, and equivalences thereto.

What is claimed is:

1. A bus bar for a fuel cell device comprising an electrolyte sheet having corners, and at least one cell having a side edge with opposing ends adjacent to said corners, said bas bar comprising:
a bus strip of electrically conductive material in contact with said side edge of said cell, wherein the amount of material in shoulder portions of said bus strip decreases as said strip approaches end portions of said side edge.

2. The bus bar according to claim 1, further comprising at least one lead electrically connected to said bus strip and being transversely oriented with respect to said side edge of said cell.

3. The bus bar according to claim 2, wherein said lead is substantially orthogonally oriented with respect to said side edge of said cell.

4. The bus bar according to claim 2, wherein said shoulder portions extend between said at least one strip and said end portions of said side edge of said cell.

5. The bus bar according to claim 4, wherein the amount of material in said shoulder portions decreases toward said end portions of said side edge of said cell.

6. The bus bar according to claim 4, wherein a thickness of said shoulder portions of said bus strip remains substantially constant but an area of said bus strip varies along a length of said bus strip.

7. The bus bar according to claim 6, wherein said shoulder portions of said bus strip are tapered toward said end portions of said side edges.

8. The bus bar according to claim 6, wherein said shoulder portions of said bus strip are beveled toward said end portions of said side edges.

9. The bus bar according to claim 4, wherein a plurality of leads are electrically connected to said bus strips, said lead strips being substantially uniformly spaced and orthogonally oriented along a length of said side edge of said cell.

10. The bus bar according to claim 9, wherein shoulder portions are present on either side of said lead strips, and wherein the amount of material in said shoulder portions of said bus strip decreases in a direction away from each lead.

11. A stress reducing bus bar for an electrolyte sheet having corners, and at least one cell having a side edge with opposing ends adjacent to said corners, comprising:
a bus strip of electrically conductive material in contact with said side edge of said cell,
at least one lead electrically connected to said bus strip and being transversely oriented with respect to said side edge of said cell,
wherein the amount of material in shoulder portions of said bus strip flanking said lead strip decreases in a direction away from said lead strip, and in a direction toward end portions of said side edge.

12. The stress reducing bus bar according to claim 11, wherein the amount of material in said shoulder portions decreases such that I²R losses are substantially minimized and substantially uniform along the length of said bus strip.

13. The stress reducing bus bar according to claim 11, wherein said lead is substantially orthogonally oriented with respect to said side edge of said cell.

14. The stress reducing bus bar according to claim 11, wherein a thickness of said shoulder portions of said bus strip remains substantially constant but an area of said bus strip varies along a length of said bus strip.

15. The stress reducing bus bar according to claim 11, wherein a plurality of leads are electrically connected to said bus strips, said lead strips being substantially uniformly spaced and orthogonally oriented along a length of said side edge of said cell.

16. The stress reducing bus bar according to claim 11, wherein said shoulder portions are tapered.

17. The stress reducing bus bar according to claim 16, wherein said tapered shoulder portions are defined by straight lines.

18. The stress reducing bus bar according to claim 16, wherein said tapered shoulder portions are defined by curved lines.

19. The stress reducing bus bar according to claim 11, wherein said electrically conductive material of said bus strip is an alloy of silver.

20. The stress reducing bus bar according to claim 11, wherein said electrolyte sheet includes multiple cells.

21. The bus bar according to claim 1, wherein said fuel cell device has a supporting layer of flexible ceramic material, and said bus strip is mounted on said supporting layer.

22. The bus bar according to claim 1, wherein said electrolyte sheet is no more than 45 microns in thickness.

23. A stress reducing bus bar for an electrolyte sheet having corners according to claim 21, wherein said fuel cell device includes an array of a plurality of cells.

24. An improved fuel cell device comprising:
a thin, flexible layer of ceramic electrolyte material that supports an array of paired electrodes that form, in conjunction with said layer, an array of fuel cells;
a bus bar having a bus strip in contact with a side edge of the array of cells, wherein the amount of material in shoulder portions of said bus strip decreases as said strip approaches end portions of said side edge.
